(19) United States
(12) Patent Application Publication
(10) Pub. No.: US 2008/0299244 A1
(43) Pub. Date: Dec. 4, 2008

(54) Apparatus and Method for Producing Optical Molded Parts

(75) Inventor: Pierre GLAESENER, Bissen (LU)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/754,610

(22) Filed: May 29, 2007

(51) Int. Cl. B29C 45/57

(52) U.S. Cl. 425/150; 264/40.5

(57) ABSTRACT

In an injection compression mold (12), a counter force cylinder (42) operates to angle (α), over time, a first plate (36) relative to a second upright plate (44). In abutting engagement and under clamp tonnage, the first and second plates (36, 44) define a mold cavity (18). To permit an angle of inclination (α) to be adjusted and finally to place the plates in parallel, a bearing (100) and a complementary bushing (140) are respectively positioned on surfaces (50) of the first plate (36) and the second plate (44). A strain gauge (102), preferably located in a hollow bore (101) of the bearing (100), measures force acting on the bearing (100) and/or bushing (140). Force (F_{CFC}) generated by the counter force cylinder (42) is then varied in response to the measured force in the bearing/bushing, with the force (F_{CFC}) generated by the counter force cylinder (42) regulated to reflect, but slightly exceed, force (80) experienced within the mold cavity (18) during injection.

### BACKGROUND OF THE INVENTION

This invention relates, in general, to an apparatus and method of producing optically molded parts and is particularly, but not exclusively, applicable to a compression molding system for the production of large, optically-transparent plastic sheets, such as windows for cars.

### SUMMARY OF THE PRIOR ART

In the production of glazing units (such as windscreens and headlight lenses for cars), optical perfection is a critical success factor for the manufacturer. Any blemish in either the surface or the body of the plastic, e.g. polycarbonate, sheet renders the molded product sub-standard and subject to rejection. Not only does this result in scrap that has a direct cost overhead for the manufacturer, but the return on capital employed (for the machine) is reduced and the overall productivity and profitability of the manufacturer is thus adversely affected.

In the molding of plastic articles, it is known that limited cavity pressure and reduced internal shear within the melt during injection augment the overall properties and finish of the molded sheet. Specifically, with lower shear, lower internal stresses are experienced within the molded part. Conversely, with increasing internal stresses, transparent plastic materials become increasingly more opaque and, more particularly, begin to acquire either a coloured hazing effect or internal stress cracks (“stress whitening”) that both cause distortion in any image viewed through the solidified plastic.

In terms of the production of transparent plastic sheets and the like, compression molding is a prevalent technology. In compression molding, a mold cavity is established through the bring together of mold plates. Molten plastic is then injected into the cavity. At some point during the injection phase, under the controlled application of applied clamp force, the plates of the mold are brought into closer relation to compress the plastic melt and thereby either to cause the melt to fill all the available space in the mold cavity or otherwise generally to compress the melt against the cool molding surfaces.

One particular compression molding technique employs an inclined mold plate whose angle of inclination is set, during melt injection, by operation of a bank of hydraulic cylinders (or “upper counter force cylinders”) that generate force sufficient to resist melt injection pressure. Lower counter force cylinders provide a complementary (balancing/re-orientating) role within the mold, although these lower counter force cylinders do not contribute to the mechanism by which angle of the inclined plate is initially set.

The angle of inclination is permitted by virtue of complementary bushings coupled to and located along upper and lower edges of the inclined plate (e.g. the cavity plate) and is defined relative to a second plate (e.g. the core plate) held substantially perpendicular to the major axis of the machine nozzle and parallel to mounting faces of respective platens of the injection molding machine. In essence, the bushings can be considered to provide a longitudinal swivel bearing that permits the inclinable plate to be rotated (along its top edge) about cooperating bearing surfaces on the inclined plate and second plate. In this configuration, the upper counter force cylinders exert a constant but highly resistive force on the bearings, with this resistive force designed always to surpass the maximum possible cavity force (and thus to resist opening of the inclined plate/mold during injection of melt). The angle of inclination continuously decreases with an increasing degree of clamping applied to the device.

The inclined plate design and operation can be understood with reference to US patent application US2004/0169296 and German patents DE10259076, DE10302102 and DE10202246.

Since the angle of the inclined plates varies during the injection cycle and it is conventional that the hot runner (and therefore the injection nozzle) interfaces into this hot side of the mold, a bendable injection path and/or a flexible manifold is required.

The benefits of the use of such tilting compression (relative to conventional parallel compression) molding are that there is a small applied stroke at commencement of flow, but a large stroke at the flow path end. Consequently, less material must be redistributed and a longer flow path is realizable.

From an injection perspective, the initial cavity pressure/force at the start of injection is zero, whereas this cavity force inevitably builds over time with the delivery of increasing volumes of melt. In practical terms, this means that the bushing is subjected to the entire force developed by the upper counter force cylinders for the entire time, and the force experienced/seen by the bushing (F_{Bushing}) varies from high (at the start of injection) to relatively low (at the end of injection). Since the bushing must initially and independently bear and resist the high resistive force generated by the upper counter force cylinders, the bearing is substantial in terms of both its size and material. Such a conventional bearing therefore is both relatively expensive and, more critically, takes up significant real estate in relation to the total available molding surface. The latter point is of particular concern in the glazing market, since glazed units (such as windows) generally have large surface areas and any reduction in available molding surface between a machine's platens limits commercial opportunity. Indeed, to accommodate both the mold and the bearings for the inclined plate, it may in fact be necessary for a manufacturer of glazed parts to purchase a physically larger machine (with increased tie bar separation) to accommodate the overall dimensions of the inclinable mold plate and its related bearings, rather than a smaller-sized machine having platens and a clamp unit sufficiently adequate to resist injection pressures and to mount a mold for a similarly sized plastic part made from opaque plastic material.

### SUMMARY OF THE INVENTION

According to a first aspect of the present invention there is provided a method of injection compression molding parts in a mold cavity defined between a first plate and a second plate, the first plate being selectively inclinable relative to the second plate, the first plate inclined by operation of force applied substantially along one edge of the first plate by a counter force cylinder, the first plate having a bearing and wherein the second plate has a complementary bushing into which the bearing engages and rotates, the method comprising: determining a magnitude of force acting across at least one of the bearing and its bushing; exercising dynamic control of force (F_{CFC}) generated by the counter force cylinder in response to the determined magnitude of force, whereby the force in the bushing (F_{BUSHING}) is modeled to reflect a force profile and exceed an instantaneous value of a cavity force in the mold cavity.

According to another aspect of the present invention there is provided an injection compression molding system containing: a first plate having a front surface and a rear surface; a second plate having a front surface closable against the front surface of the first plate to define a mold cavity between the first and second plates; a bearing and a bushing that cooperate together, one of the bearing and the bushing being coupled to the front surface of the first plate, while the other one of the bushing and the bearing is coupled to the front surface of the second plate; a counter force cylinder coupled to the first plate and arranged to vary inclination of the first plate relative to the second plate during injection compression, the counter force cylinder generating cylinder force (F_{CFC}) that, in use, is applied to the bushing and bearing; means for assessing a magnitude of the force (F_{BUSHING}) acting across at least one of the bearing and its bushing; and a controller coupled to the counter force cylinder and arranged dynamically to control, in response to the magnitude of force and during injection compression, cylinder force (F_{CFC}).

In yet another aspect of the present invention there is provided an injection compression mold comprising: a first plate having a front surface and a rear surface; a second plate having a front surface closable against the front surface of the first plate to define a mold cavity between the first and second plates; a first bearing and a first bushing that cooperate together, one of the first bearing and the first bushing being coupled to the front surface of the first plate, while the other one of the first bushing and the first bearing is coupled to the front surface of the second plate, the first bearing and the first bushing permitting the first plate to be selectively inclined relative to the second plate; wherein the first bearing is hollow and includes means for determining a magnitude of the force (F_{BUSHING}) acting across at least one of the first bearing and the first bushing.

The present invention therefore advantageously provides a mechanism that reduces the average and (generally also the) instantaneous force acting on a bearing in a tilting mold used in injection compression molding.

Specifically, an aspect of the present invention provides the dynamic control of, typically, hydraulic pressure (from counter force cylinders) acting to angle an inclined plate in an injection compression molding environment.

Beneficially, at least one aspect described herein permits the bearing's overall size to be reduced and/or for the system to benefit from reduced wear and/or improved part quality.

### BRIEF DESCRIPTION OF THE DRAWINGS

Exemplary embodiments of the present invention will now be described with reference to the accompanying drawings, in which:

FIG. 1 shows a conventional inclined mold shown in situ between platens of a schematically represented, conventional injection molding machine;

FIG. 2 is a graph that illustrates force variation within a bushing of the inclined compression mold of FIG. 1;

FIG. 3 is a force diagram section view through the inclined mold of FIG. 1;

FIG. 4 is a section view through a bearing embodying preferred features of the present invention;

FIG. 5 is a partial view of the bearing of FIG. 4 shown in situ within a mold;

FIG. 6 is a graph that illustrates force variation within the bushing of the inclined compression mold of FIG. 5; and

FIG. 7 is a force diagram and section view through the inclined mold of FIG. 5.

### DETAILED DESCRIPTION OF A PREFERRED EMBODIMENT

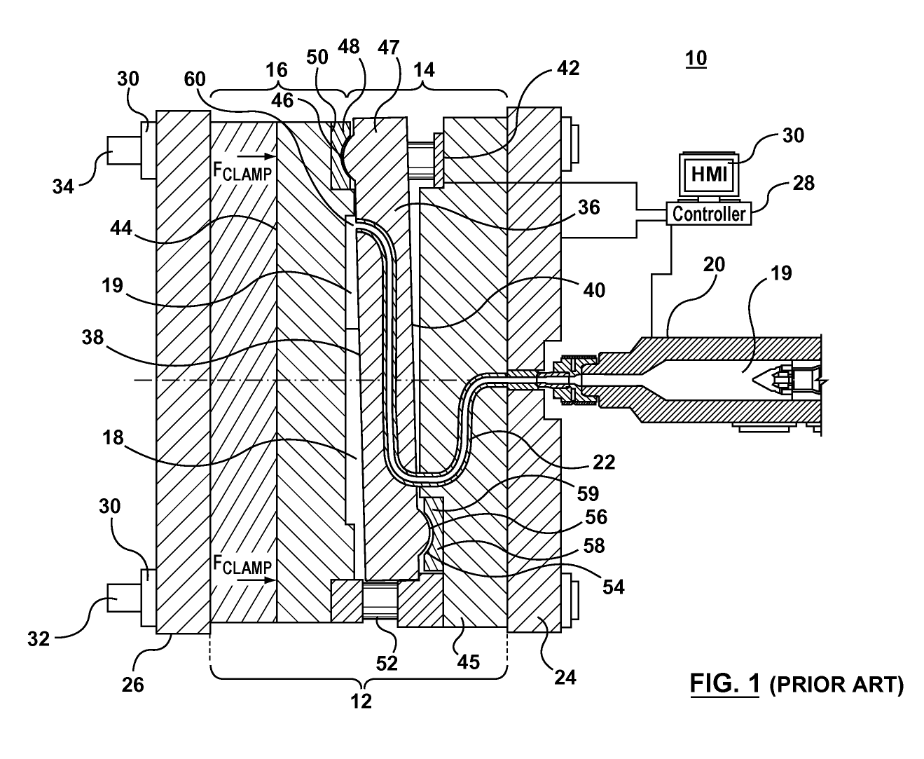

To provide a context for the present invention, FIG. 1 shows a prior art injection molding system 10 that supports an injection compression molding operation. An inclined mold 12 is shown in situ within the injection molding system 10. The structure and function of the inclined mold 12 follows that detailed in and patents and applications identified above. As will be understood, the mold 12 contains a plurality of individual but interacting plates and components that define two complementary mold halves 14, 16. When brought together, the mold halves 14, 16 together define at least one mold cavity space 18 that receives melt 19, e.g., molten plastic resin, and ultimately promotes solidification of that melt into a molded article.

In terms of system components, the injection molding system 10 is wholly unremarkable since its parts are all well known to the skilled addressee. For this reason, FIG. 1 merely illustrates that the system 10 includes some form of plasticizing/injection unit 20 that interfaces to a hot side of the inclined mold 10 through a suitable runner system 22, such as a flexible hot runner. In use, the mold halves 14, 16 are respectively secured to one of a stationary platen 24 and a moving platen 26 of the injection molding system 10. Under the control of machine controller 28 (that includes a human machine interface 30) and during the molding cycle, the platens 24, 26 and therefore the mold halves 18, 20 are selectively clamped together. Particularly, a clamp unit 30 selectively and conventionally engages/disengages individual tie bars 32, 34. More specifically, hydraulic actuation of pistons within the clamp unit 30 generates applied tonnage/clamp force (F_{CLAMP}) through a force path that includes the tie bars 32, 34, the clamp unit 30 and mold 12.

The molding system 10 may, however, be adapted to support the improvements to the compression molding process and inclined mold that will be described subsequently. In terms of the general configuration of the mold 12, FIG. 1 shows that the mold includes an inclinable plate 36 (interchangeably referred to as the “first plate” or “inclined plate”) that has a mold cavity-side front surface 38 and a rear surface 40. In the top corners or towards an upper edge of the first plate 36, a bank of upper counter force cylinders 42 (generally extending across the width of the mold) permit, in use, the first plate 36 to be forced forward to angle and selectively incline the first plate 36 relative to a second plate 44 that is fixed in an upright position. The upper counter force cylinders 42 act between the rear surface 40 of the first plate 36 and an upright and stationary datum usually realized by a manifold plate 45 held substantially parallel to the second plate. Actuation of the upper counter force cylinders 42 generates an upper cylinder counter force (F_{CFC}) that causes a generally cylindrical bearing surface 46 of a first bearing 47 (located in the front surface 38) to rotate within a complementary bushing 48 typically recessed into a mold cavity-side front surface 50 of the second plate 44. As previously indicated, the first bearing 47 is substantial in size and is of solid construction; these physical attributes permit the bearing 47 to withstand the varying forces (F_{BUSHING}) generated by the upper counter force cylinders 42 within the first bearing 47 and its bushing 48 (as a whole).

Along a bottom edge of the mold 12, a bank of lower counter force cylinders 52 is coupled (and acts) between the second plate 44 and the manifold plate 45. To permit the inclination of the first plate 36, a second bearing 54 includes a generally cylindrical bearing surface coupled to the rear surface 40 of the first plate 36. The second bearing interacts with a complementary bearing surface 58 of a second bushing 59 fixed to (and typically recessed within) the manifold plate 45. Again, the second bearing 54 and its bushing 59 are substantial in size and are of solid construction.

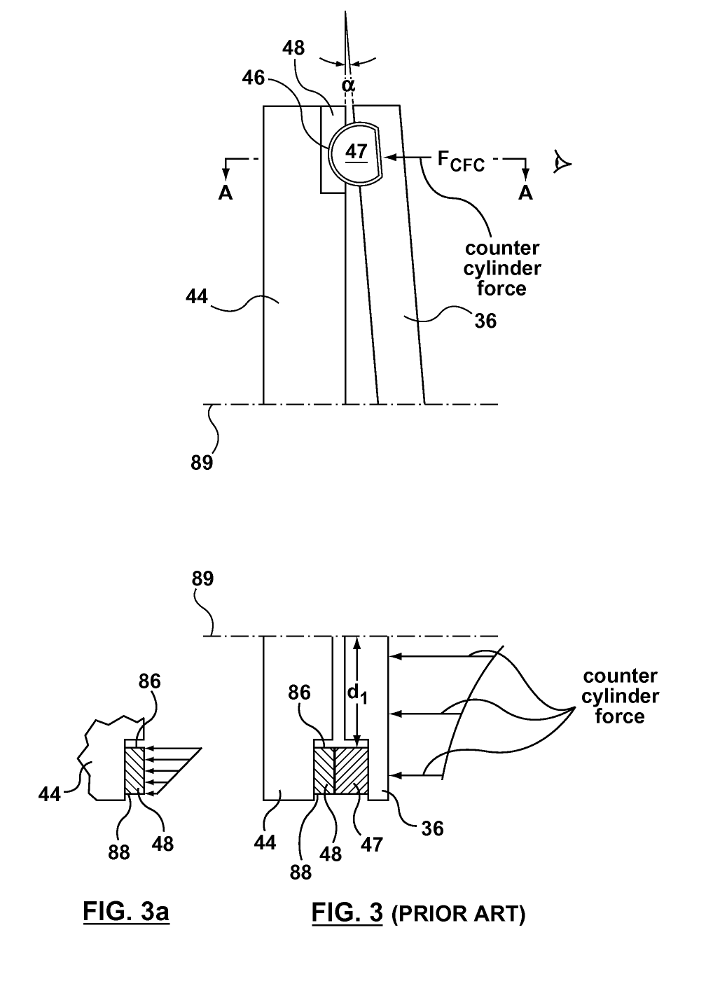

Through the angling of the first plate 36, melt 19 injected into the mold cavity 18 at a gate 60 initially sees a small channel in the mold cavity that progressively widens as the melt moves away from the gate 60. As summarized above and as described in DE 10259076, the angle of inclination (α—see FIG. 3) between the first plate 36 and the second plate 44 continuously decreases with an increasing degree of closing applied to the mold 12. Specifically, the tonnage from the clamp unit 30 acts to overcome the force generated by the parallel banks of counter force cylinders and the cavity force.

Clearly, while not expressly shown, the mold 12 includes pairs of first and second bearings to provide a certain degree of balance. The above description and the accompanying drawings concentrate on either a particular quadrant or either the left or right side of the mold (when split downwardly through a centreline of the mold 12), as will be readily understood.

With the bank of upper counter force cylinders acting across the width of the prior art mold 12, it has only now been realized that the hydraulic actuation of those counter force cylinders causes deflection of the inclined (first) plate 36. This deflection results in a non-uniform load being seen across the width of the various bearings and complementary bushings in the prior art mold of FIG. 1. More particularly, the upper cylinder counter force (F_{CFC}) causes the first plate 36 to bow increasingly as one moves towards the central region of the first plate 36.

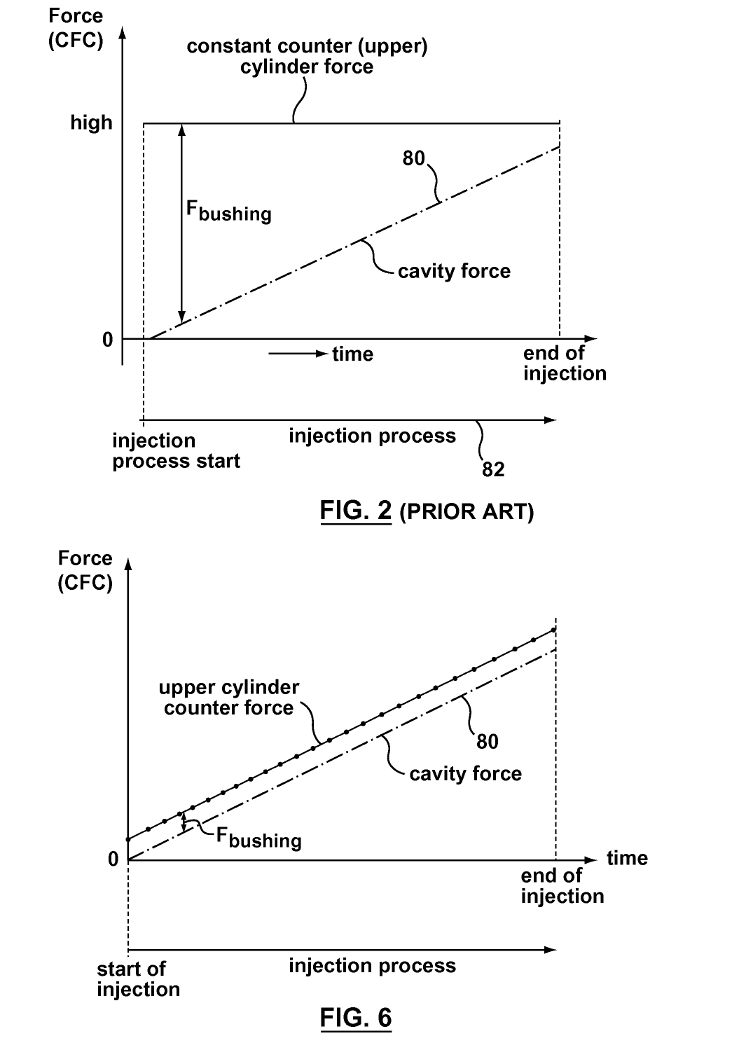

FIG. 2 is a graph that illustrates how, in the prior art arrangement of FIG. 1, cavity force 80 varies as a function of counter cylinder force (F_{CFC}) with elapsed time during an entire injection compression process 82. FIG. 2 particularly illustrates how the prior art solution applies a constant counter cylinder force (F_{CFC}) over the entire injection cycle/process, with this resulting in a varying amount of force seen in the bearing and, particularly, its complementary bushing over time. Specifically, at any point during the injection process 82, force in the bushing (F_{BUSHING}) is the net difference between the constant counter cylinder force (F_{CFC}) and the cavity force.

FIG. 3 shows top and side views through the first (inclined) plate 36 and the second plate 44 of the mold 12. Particularly, FIG. 3 shows how the upper counter cylinder force (F_{CFC}) acts parallel and into the first bearing 47 and its complementary bushing 48. For reasons of clarity, the mold cavity is not shown within FIG. 3. In a lower part of FIG. 3, a section through bearing 47 (along the line A-A) is shown, which section essentially shows a view looking down at and along the top of the mold 12. This particular section shows the solid nature and contact surfaces between the first bearing 47 and its complementary bushing 48.

In FIG. 3a, the effect of the counter cylinder force (F_{CFC}) across the complementary bushing 48 (to the first bearing 47) is illustrated and shows that the bushing sees considerably higher stresses/forces towards its inner edge 86 (nearest the centre of the platen/mold) relative to its outer edge 88, which force distribution arises from the nature of the applied counter cylinder force (F_{CFC}). The inner edge 86 of the bearing 47 and bushing 48 are therefore displaced from the centre line 89 of the mold 12 by a distance d₁.

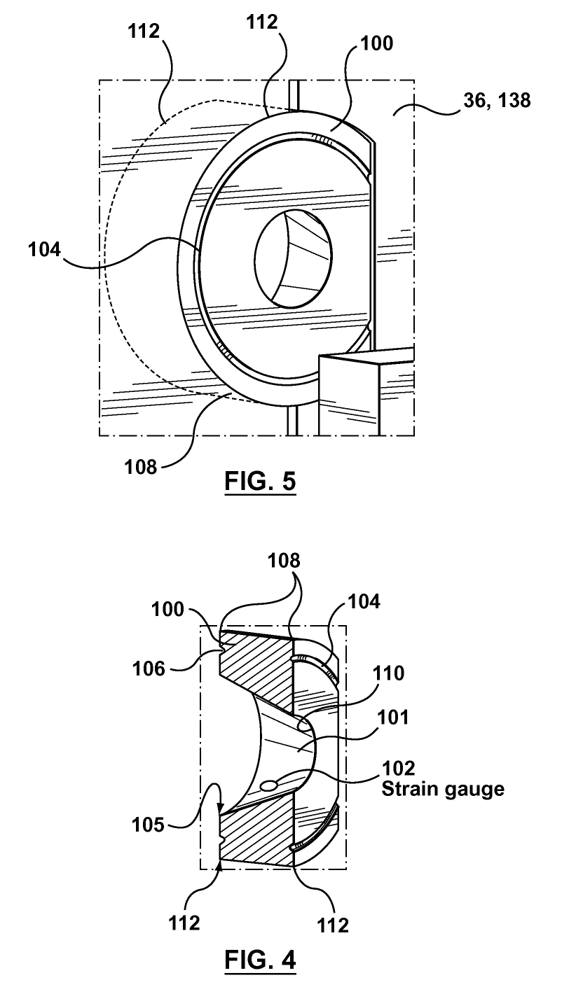

Turning to FIG. 4, a preferred embodiment of a new bearing 100 according to an aspect of the present invention is shown. Unlike the prior art, as can be seen from the section view, the bearing 100 includes a hollow bore 101 that supports the location of a strain gauge 102 or the like. Since the bearing 100 remains generally cylindrical, it is generally substitutable into the prior art mold (of FIG. 1), or at least can be used within a new inclined plate 138 that makes use of the concepts of DE 10259076 (and related concepts). However, the new bearing 100 may now be made smaller in size relative to the corresponding prior art bearing 47, with this size reduction effectively allowing the useable surface area between the platens in a molding system to be increased (relative to the prior art). The reasons that permit the new bearing 100 to be reduced in size are described below.

The new bearing 100 will act against a complementary shaped bearing surface of a bushing on the second (upright) plate 44 in a manner similar to that illustrated in FIG. 2. The new bearing 100 and its accompanying strain gauge could be retrofitted in the existing system of FIG. 1, although the new bearing 100 and an appropriately (re-sized) bushing could be supplied with a new first plate 138 (see FIG. 5) or just as new components.

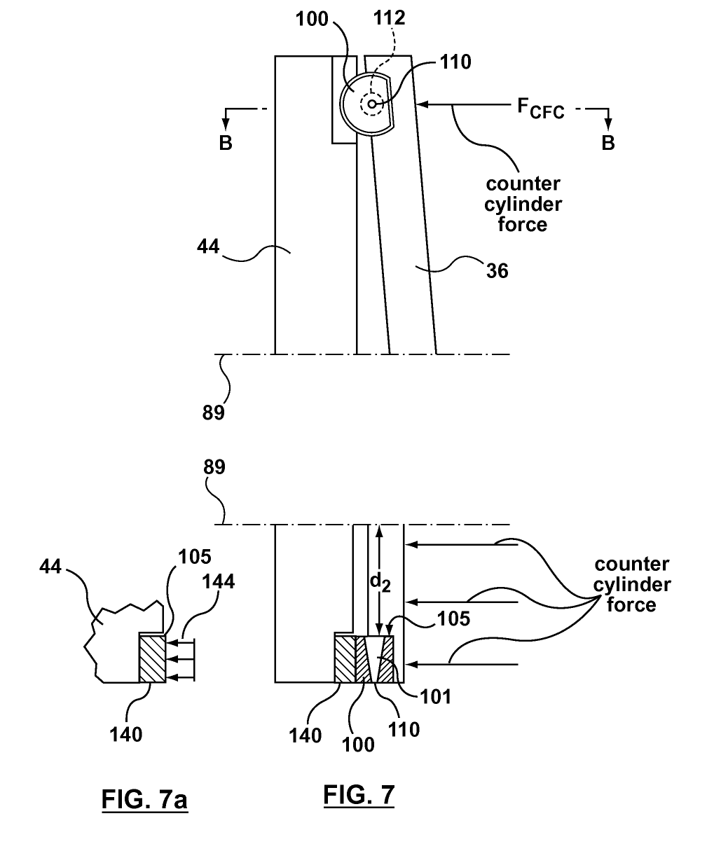

The strain gauge 102, which is linked to the machine controller 28, measures strain experienced within and across the bearing 100 before and during the injection compression process (see FIG. 6). In response to the measured forces/strain, the machine controller 28 gradually increases the upper counter cylinder force in line with the increase in cavity force such that the force in the bushing (F_{BUSHING}) exceeds the cavity force by a substantially constant safety factor. Consequently, the average force in the bushing is reduced and the dynamic adjustment of counter cylinder force minimizes the force through both the bearing 100 and its complementary bushing (reference numeral 140 of FIG. 7) throughout the injection compression cycle.

Since the cavity force is initially zero at the instant injection commences, the upper counter cylinder force is ramped up or pre-set to a limited but finite level above zero prior to commencement of the injection process. At the end of injection, the upper counter cylinder force will only then essentially correspond to the constantly high force experienced in the prior art. In this way, the amount of overall force experienced in the bushing (F_{BUSHING}) is reduced relative to the prior art; this can be seen by comparing FIG. 6 with FIG. 2. Both the new bearing 100 and its bushing 140 can be reduced in size.

Towards a point in time when the cavity is filled, the mold is fully closed to parallel by actuation of the clamp cylinders. In other words, the machine controller 28 performs parallelism control through the clamp unit 30 and, as necessary, further control of the banks of counter force cylinders.

Since there is decreased force within the newly configured bearing 100 and its bushing 140, the overall effect is that, for identically treated materials having identical properties, there is reduced wear experienced by the various bearings and bushings. With decreased wear and decreased load, any compression molding system (such as that of FIG. 1) that utilizes the new bearing 100 can now benefit from greater part repeatability and part quality. Particularly, with reduced overall wear, there is a reduced likelihood that the angle of inclination (α) between the plates will vary with time or, in other words, the separation between the first plate 36 and the second plate 44 is rendered substantially constant during the lifetime of the mold.

Also, in a preferred embodiment, a stress release notch 104, 106 is cut into the side faces of the bearing 100 at a location relatively proximate to an outer (cylindrical) surface defined parallel to an axis of the internal bore 101. The notch 104, 106, which may be on both sides of the bearing 100, acts to relieve peak stresses experienced at each edge 112 by providing some limited flexibility in the bearing surface at the edge 112.

In a preferred embodiment, as shown in FIG. 5, the improved bearing 100 is shown located within an inclinable plate.

In addressing a total solution for a bearing, another aspect contemplates that the internal bore 101 is conically-shaped with an smaller diameter 110 facing outwardly and away from a central region of the mold 12 and a larger diameter 112 facing inwardly towards the centre of the mold 12. The shaping of the bore 101 of the bearing 100 compensates for deflection of the first (inclined) plate that arises from the application of counter cylinder force across the width of the mold. In this way, the bearing 100 and its complementary bushing 140 are exposed to a substantially constant amount of force which reduces overall wear and provides greater balance; this is seen in the accompanying force diagram in FIG. 7a.

FIG. 7 is similar to FIG. 3, although it now shows and illustrates how the new bearing 100 substantially equalizes force distribution (i.e. the force profile 144) through the bushing 140. Consequently, the provision of a smaller male bearing 100 and complementary female bushing 140 increases the available space between the new bearing/bushing and a centre line 89 of the inclinable mold. In other words, contrasting FIG. 7 with FIG. 3, inner edges 105 of the bearing 100 and/or bushing 140 is/are therefore displaced from the centre line 89 in the mold by a distance d₂, where d₂>d₁.

In overview, dynamic modeling of the cavity force by the cylinder counter force can be achieved through the location of a strain gauge (or the like) in any suitably shaped internal region of a bearing. While the preferred embodiment makes use of a generally cylindrical bearing having a cone-shaped internal bore 101, this is merely preferred and reflects the desire and benefit of combining cavity force modeling with complementary but independent mechanical compensation of forces induced across the width of the bearing and bushing by operation of the counter force cylinders 42. By having the upper cylinder counter force mirror (but exceed by an appropriate safety factor) the cavity force, the average load seen through the bearing can therefore be reduced and the bearing can be reduced in size and/or cheaper materials (having lower strength properties) can be used in its manufacture. Also, the concept of having a force-profiled (substantially) conical internal bore 101 can be implemented independently of the measurement of applied force and controlled variation of counter cylinder force and this mechanical change can again contribute in reducing the overall size of the bearing 100 (and its related bushing 140).

With respect to the second bearing 54 and bushing 59 associated with the lower counter cylinders 52, the issue of space is not as problematic since the second bearing is positioned between the first plate and the manifold plate and its location therefore has no direct impact on mold mounting capabilities. Of course, the second bearing could also benefit from being made smaller by using a suitably modeled internal bore to modify its load characteristics.

It will, of course, be appreciated that the above description has been given by way of example only and that modifications in detail may be made within the scope of the present invention. For example, while a principal aspect of the present invention is the control of upper cylinder counter force through measured force experienced in the hollow bearing, it will be understood that benefit alone can be achieved by using a force-profiled (internal cone-shaped bearing). More particularly, by providing a bearing has a wall-thickness that is force-profiled, the use of that bearing alone could increase the available molding surface because such a force-profiled bearing can be made smaller in size. Furthermore, while a preferred embodiment of the present invention contemplates measurement of force (with a strain gauge in the hollow internal bearing), force measurement could be implied or made elsewhere within the system. For example, cavity melt pressure could be measured to imply load on the bearing, although it will be understood that direct measurement (wherever this is taken along the first plate 36, for example) will provide information that can be used to most accurately model an instantaneous cavity force.

One could also determine the approximate force in the cavity based on either the position of the injection screw (since this correlates with the volume of melt in the cavity) or the injection oil pressure (which correlates with the melt pressure at the gate) and then to control the cylinder force accordingly. However, these mechanisms are of course less accurate than direct measurement undertaken at the bearing.

It is merely design option as to which of the cylindrical bearing or the complementary bushing is located on the front and rear surfaces of the inclined (first) plate 36. Conventionally, the complementary bushings are coupled to the upright (second) plate 44 and the manifold plate 45. Equally, while the preferred embodiment describes the first bearing as being located on a front face of the first plate and the complementary bushing to be recessed on the second plate, it is equally plausible for these locations to be reversed such that the bushing is on the inclinable (first) plate and the bearing on the second (upright plate).

While the preferred embodiment has been described with reference to glazing application, the present invention could of course find application in other molding systems, using non-transparent materials, where an inclined mold is used.

What is claimed is:

1. A method of injection compression molding parts in a mold cavity defined between a first plate and a second plate, the first plate being selectively inclinable relative to the second plate, the first plate inclined by operation of force applied substantially along one edge of the first plate by a counter force cylinder, the first plate having a bearing and wherein the second plate has a complementary bushing into which the bearing engages and rotates, the method comprising:
determining a magnitude of force acting across at least one of the bearing and its bushing;
exercising dynamic control of force (F_{CFC}) generated by the counter force cylinder in response to the determined magnitude of force, whereby the force in the bushing (F_{BUSHING}) is modeled to reflect a force profile of and exceed an instantaneous value of a cavity force in the mold cavity.

2. The method according to claim 1, wherein the force in the bushing (F_{BUSHING}) exceeds the cavity force by a substantially constant safety factor.

3. The method according to claim 1, wherein determining the magnitude of force comprises:
measuring strain experienced within and across the bearing before and during the injection compression process.

4. The method according to claim 1, wherein a maximum force (F_{CFC}) generated by the counter force cylinder occurs towards an end of the injection compression process and a minimum force (F_{CFC}) generated by the counter force cylinder occurs at commencement of the injection compression process.

5. The method according to claim 1, wherein the mold cavity is fully closed to parallel by actuation of clamp cylinders

6. The method according to claim 1, wherein the molded part is a glazing unit.

7. The method according to claim 1, wherein the force in the bushing (F_{BUSHING}) is modeled to reflect the force profile and exceed the instantaneous value of the cavity force in the mold cavity at any time during injection compression.

8. An injection compression molding system containing:
a first plate having a front surface and a rear surface;
a second plate having a front surface closable against the front surface of the first plate to define a mold cavity between the first and second plates;
a bearing and a bushing that cooperate together, one of the bearing and the bushing being coupled to the front surface of the first plate, while the other one of the bushing and the bearing is coupled to the front surface of the second plate;
a counter force cylinder coupled to the first plate and arranged to vary inclination of the first plate relative to the second plate during injection compression, the counter force cylinder generating cylinder force (F_{CFC}) that, in use, is applied to the bushing and bearing;
means for assessing a magnitude of the force (F_{BUSHING}) acting across at least one of the bearing and its bushing; and
a controller coupled to the counter force cylinder and arranged dynamically to control, in response to the magnitude of force and during injection compression, cylinder force (F_{CFC}).

9. The injection compression molding system according to claim 8, wherein the controller is arranged to induce a force in the bushing (F_{BUSHING}) that both reflects a force profile of and exceed an instantaneous value of a cavity force in the mold cavity.

10. The injection compression molding system according to claim 9, wherein a plurality of counter force cylinders are coupled along an upper edge of the first plate.

11. The injection compression molding system according to claim 10, wherein the bearing and bushing are substantially aligned with the counter force cylinders.

12. The injection compression molding system according to claim 8, wherein the bushing is recessed within the second plate (44).

13. The injection compression molding system according to claim 8, wherein the bearing is hollow and contains a strain gauge to measure forces within the bearing.

14. The injection compression molding system according to claim 13, wherein the bearing includes a cone-shaped internal surface arranged to compensate for cylinder forces induced across a width of the bearing and bushing by operation of the counter force cylinders.

15. The injection compression molding system according to claim 8, further including one of:
a position sensor for measuring the position of an injection screw (20) to infer cavity pressure in the mold cavity;
and wherein the means for assessing the magnitude of force is responsive to the measured position to control the cylinder force (F_{CFC}).

16. The injection compression molding system according to claim 8, further including one of:
a pressure sensor for determining melt pressure at a gate in the mold cavity to infer cavity pressure;
and wherein the means for assessing the magnitude of force is responsive to the measured pressure to control the cylinder force (F_{CFC}).

17. An injection compression mold comprising:
a first plate having a front surface and a rear surface;
a second plate having a front surface closable against the front surface of the first plate to define a mold cavity between the first and second plates;
a first bearing and a first bushing that cooperate together, one of the first bearing and the first bushing being coupled to the front surface of the first plate, while the other one of the first bushing and the first bearing is coupled to the front surface of the second plate, the first bearing and the first bushing permitting the first plate to be selectively inclined relative to the second plate;
wherein the first bearing is hollow and includes means for determining a magnitude of the force (F_{BUSHING}) acting across at least one of the first bearing and the first bushing.

18. The injection compression mold according to claim 17, wherein the first bearing includes a cone-shaped internal surface arranged to compensate for cylinder forces (F_{CFC}) induced across a width of the first bearing and the first bushing.

19. The injection compression mold according to claim 17, further including:
a manifold plate adjacent the rear surface of the first plate; and
a plurality of counter force cylinders coupled between the manifold plate and the rear surface of the first plate, the counter force cylinders substantially aligned with the first bearing and the first bushing.

20. The injection compression mold according to claim 19, further including a second bearing and a second bushing that cooperate together, one of the second bearing and the second bushing being coupled to the rear surface of the first plate, while the other one of the second bushing and the second bearing is coupled to the manifold plate, the second bearing and the second bushing permitting the first plate to be selectively inclined relative to the second plate.

21. The injection compression mold according to claim 19, wherein the second bearing and the second bushing are different in construction to the first bearing and the first bushing.

22. The injection compression mold according to claim 17, wherein the first bushing is located within a recess.
